(19) United States
(12) Patent Application Publication
(10) Pub. No.: US 2025/0103413 A1
(43) Pub. Date: Mar. 27, 2025

(54) INFORMATION PROCESSING APPARATUS AND METHOD

(71) Applicant: Toshiba Tec Kabushiki Kaisha, Tokyo (JP)

(72) Inventor: Toshiki IWAI, Sunto Shizuoka (JP)

(21) Appl. No.: 18/793,376

(22) Filed: Aug. 2, 2024

(30) Foreign Application Priority Data
Sep. 26, 2023 (JP) 2023-163035

(51) Int. Cl. G06F 11/07; G06Q 20/20

(52) U.S. Cl. CPC G06F 11/0751; G06F 11/0709; G06Q 20/208

(57) ABSTRACT

According to one embodiment, an information processing apparatus includes a local area network (LAN) interface including a control unit and an abnormality monitoring function for monitoring whether a communication path is abnormal. The control unit is configured to disable the abnormality monitoring function of the LAN interface when it is determined a LAN cable is not connected to the LAN interface and enable the abnormality monitoring function when the LAN cable is determined to be connected to the LAN interface. Certain examples of the information processing apparatus may be a product scanner unit or the like for use in or with point-of-sale terminals.

### CROSS-REFERENCE TO RELATED APPLICATION

This application is based upon and claims the benefit of priority from Japanese Patent Application No. 2023-163035,filed Sep. 26, 2023, the entire contents of which are incorporated herein by reference.

### FIELD

Embodiments described herein relate generally to an information processing apparatus and a method.

### BACKGROUND

In systems of servers and clients, it is common to implement protocols in which requests to start communication between a server and a client are initiated from the client side. When faults occur in communication paths, there is concern with possible abnormalities occurring in communicated data. Therefore, the client side may have abnormality monitoring functions for monitoring whether the communication paths are abnormal.

Clients may operate in cooperation with servers in some cases or may operate independently (standalone) without any cooperation with servers in some cases. However, when a client has abnormality monitoring functions where a standalone client might operate without connecting to the servers, a client with abnormality monitoring functions may instead detect that the communication paths are abnormal and enter an abnormality detection state. Therefore, an operator may be required to turn off or clear the abnormality detection state (or change operating settings).

### BRIEF DESCRIPTION OF THE DRAWINGS

FIG. 1 is a diagram illustrating an overall

configuration of a commodity information management system according to an embodiment.

FIG. 2 is a perspective view illustrating an exterior of a self-service POS system.

FIG. 3 is a block diagram of a POS terminal.

FIG. 4 is a block diagram of a scanner.

FIG. 5 is a diagram illustrating a relationship between a TCP client function mounted on a LAN interface 222 and a server.

FIG. 6 is a block diagram of an image recognition apparatus.

FIG. 7 is a block diagram of a server.

FIG. 8 is a diagram illustrating a data configuration of a commodity master stored in a storage unit of a POS terminal.

FIG. 9 is a diagram illustrating an example of LAN connection information storage.

FIG. 10 is a diagram illustrating a data configuration of a comparison dictionary stored in a storage unit of an image recognition apparatus.

FIG. 11 is a schematic diagram illustrating functional aspects of a control unit of a POS terminal.

FIG. 12 is a schematic diagram illustrating functional aspects of a control unit of a scanner.

FIG. 13 is a schematic diagram illustrating functional

aspects of a control unit of an image recognition apparatus.

FIG. 14 is a schematic diagram illustrating functional aspects of a control unit of a server.

FIG. 15 is a flowchart of operations of a client in the related art.

FIG. 16 is a flowchart of operations of a client according to an embodiment.

FIG. 17 is a flowchart of operations of a scanner and an image recognition apparatus.

### DETAILED DESCRIPTION

In general, according o one embodiment, an information processing apparatus includes a local area network (LAN) interface including a control unit and an abnormality monitoring function for monitoring whether a communication path is abnormal. The control unit is configured to disable the abnormality monitoring function of the LAN interface when it is determined a LAN cable is not connected to the LAN interface and enable the abnormality monitoring function when it is determined the LAN cable is connected to the LAN interface.

Hereinafter, certain example embodiments of an information processing apparatus and a method will be described with reference to the drawings. An present disclosure is not limited to the specific example embodiments described.

### Commodity Information Management System

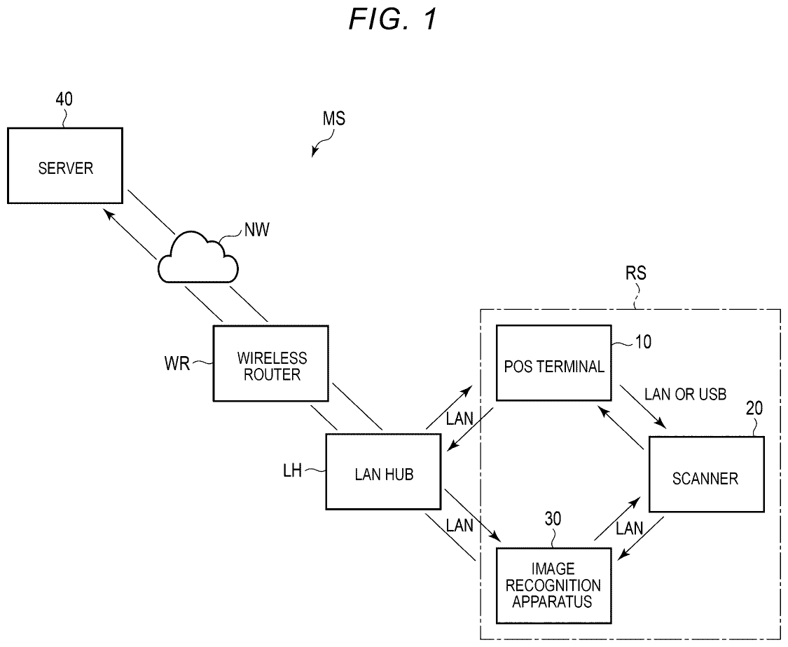

First, a commodity information management system MS according to an embodiment will be described with reference to FIG. 1. FIG. 1 is a diagram illustrating an overall configuration of the commodity information management system MS. The commodity information management system MS includes a commodity information registration system RS and a server 40.

The commodity information registration system RS includes a point of sales (POS) terminal 10, a scanner 20, and an image recognition apparatus 30. The POS terminal 10 and the scanner 20 connected to be able to communicate with each other via a local area network (LAN) or a universal serial bus (USB). The scanner 20 and the image recognition apparatus 30 are connected to be able to communicate with each other via the LAN. In general, and in this example, the image recognition apparatus 30 is separate from POS terminal 10 and also the scanner 20.

In the present embodiment, Ethernet and a transmission control protocol (TCP) are combined for use in LAN communication, but a protocol for communication is not limited to this example.

The POS terminal and the image recognition apparatus 30 are connected to be able to communicate through a LAN hub LH across the LAN. The LAN hub LH can be connected to communicate with wireless router WR via the LAN. The wireless router WR can then wirelessly communicate with the server 40 via a network NW.

The scanner 20 takes pictures of (images) a commodity being registered at the POS terminal 10 and acquires (captures) a commodity image. The scanner 20 transmits the acquired commodity image to the image recognition apparatus 30 via the LAN. The scanner 20 is separately able to detect and decode a commodity barcode (e.g., a 1-dimensional code or a 2-dimensional code) depicted in the acquired commodity image. That is, the scanner 20 reads information stored in the commodity barcode. A decoding result of the commodity barcode includes a commodity code stored in the commodity barcode. The scanner 20 also transmits this decoding result to the image recognition apparatus 30 via the LAN when acquired.

The image recognition apparatus 30 receives a commodity image (captured image) from the scanner 20 via the LAN. The image recognition apparatus 30 has an image or object recognition function. For example, the image recognition apparatus 30 uses a model trained through machine learning to perform image recognition (also referred to as “package recognition”) on the commodity image. Specifically, the image recognition apparatus 30 acquires feature data of an object (commodity) depicted in the commodity image by the image recognition function, compares the acquired feature data to entries in a comparison dictionary associated with different commodity codes, and can acquire a commodity code with feature data most closely matching the acquired feature data. That is, a successful image recognition result provides a commodity code for the commodity shown in the commodity image. The image recognition apparatus 30 may perform recognition on the commodity image using a method such as deep learning. The image recognition apparatus 30 transmits the image recognition result to the scanner 20 via the LAN.

The scanner 20 receives the image recognition result from the image recognition apparatus 30 via the LAN. The scanner 20 merges (compares) the code symbol decoding result and the image recognition result. Here, merging refers to acquisition of one commodity code from the decoding result and one commodity code from the image recognition result and selecting one or the other for output when necessary. That is, a merging (merged) result includes the decoded commodity barcode (i.e., the commodity code stored in the barcode) or the commodity code from the image recognition. The scanner 20 transmits the merged result to the POS terminal 10 via the LAN or the USB. The POS terminal 10 performs commodity registration based on the commodity code of the merged result received from the scanner 20.

The image recognition apparatus 30 also determines whether the commodity image received from the scanner 20 is to be used for additional learning. For example, when a difference between the acquired feature data and the feature data closest to the acquired feature data is greater than or equal to a predetermined threshold amount, the image recognition apparatus 30 determines that the commodity image received from the scanner 20 is a commodity image to be used for additional learning. The image recognition apparatus 30 transmits this commodity image (determined to be used for additional learning) and the commodity code from the barcode decoding result (received from the scanner 20) to the server 40 via the LAN.

The server 40 receives the commodity image and associated commodity code from the image recognition apparatus 30 via the LAN. The server 40 accumulates the received commodity images and commodity codes in association with each other. The server 40 performs additional learning for a model trained for commodity image recognition using the accumulated commodity images and commodity codes. The server 40 subsequently updates the trained model through the additional learning. After additional learning, the server 40 updates the comparison dictionary as appropriate. An update of the comparison dictionary includes correction of an existing record (entry) or an addition of a new record (entry). The server 40 transmits the updated trained model and the updated comparison dictionary to the image recognition apparatus 30 via the LAN.

The image recognition apparatus 30 receives the updated trained model and the updated comparison dictionary from the server 40 via the LAN. The image recognition apparatus 30 updates the currently stored trained model with the updated trained model. The image recognition apparatus 30 updates the currently stored comparison with dictionary the updated comparison dictionary.

With the commodity information management system MS, it is possible to omit manual labor otherwise necessary for repeatedly collecting commodity images for additional learning of the trained model for commodity image recognition whenever a packaging of a commodity is changed.

The server 40 manages a commodity master. The POS terminal 10 transmits payment process information (information regarding a transaction subjected to a payment process) to the wireless router WR via the LAN through the LAN hub LH. The wireless router WR transmits the received payment process information to the server 40 via the network NW. The server 40 manages the commodity master based on the received payment process information. For example, the server 40 receives the payment process information from a plurality of POS terminals 10 and tracks and updates information in the commodity master according to sales (payment process) information from each of the POS terminals 10. The management of the commodity master includes correction of an existing record and addition of a new record. The server 40 transmits the commodity master appropriate for a POS terminal 10 to each POS terminal 10 via the network NW, the wireless router WR, and the LAN hub LH.

In some examples, the image recognition apparatus 30 may transmit a commodity image received from the scanner 20 to the server 40 regardless of whether the commodity image is to be used for additional learning. In such a case, a commodity image in the server 40 may be used, for example, for analyzing an image recognition state (event) in the image recognition apparatus 30.

### Commodity Information Registration System

Hereinafter, a self-service POS system that is operated by customers themselves for purchasing a commodity will be described as an example of the commodity information registration system. However, the commodity information registration system is not limited to a self-service POS system. The commodity information registration system may be a POS system that is operated by store staff.

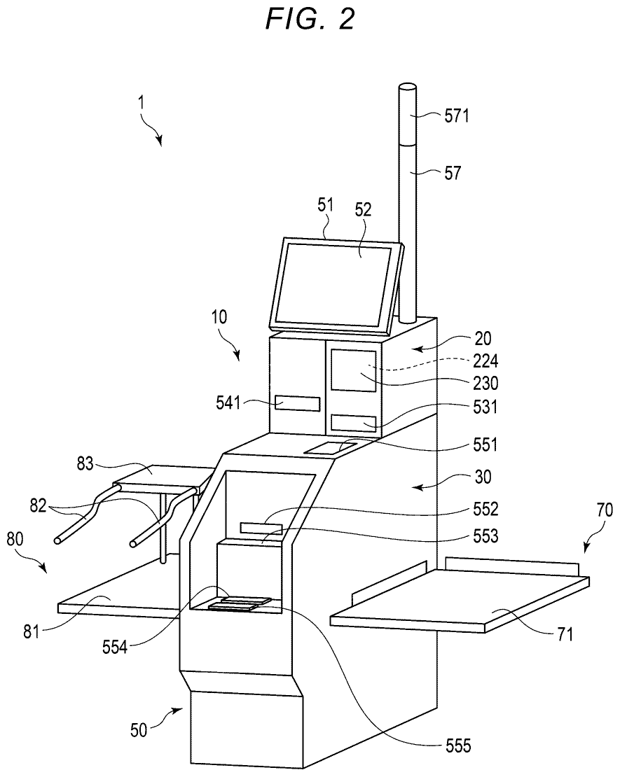

FIG. 2 is a perspective view illustrating an exterior of a self-service POS system 1. The self-service POS system 1 includes the POS terminal 10, the scanner 20 mounted on the POS terminal 10, and the image recognition apparatus 30 mounted in the POS terminal 10. Here, the self-service POS system 1 is a commodity information registration system, the POS terminal 10 apparatus, and the scanner 20 and the is a registration information recognition apparatus are 30 examples of an information processing apparatus.

The scanner 20 specifies (identifies) a commodity being purchased by a customer and transmits a commodity code of the identified commodity to the POS terminal 10. The commodity code is commodity identification information. The POS terminal 10 performs commodity registration based on the commodity code from the scanner 20 and then performs a payment process (settlement processing) for the registered commodities. The payment process is a process performed by the POS terminal 10 permitting the customer to settle (pay) a purchase price of a commodity.

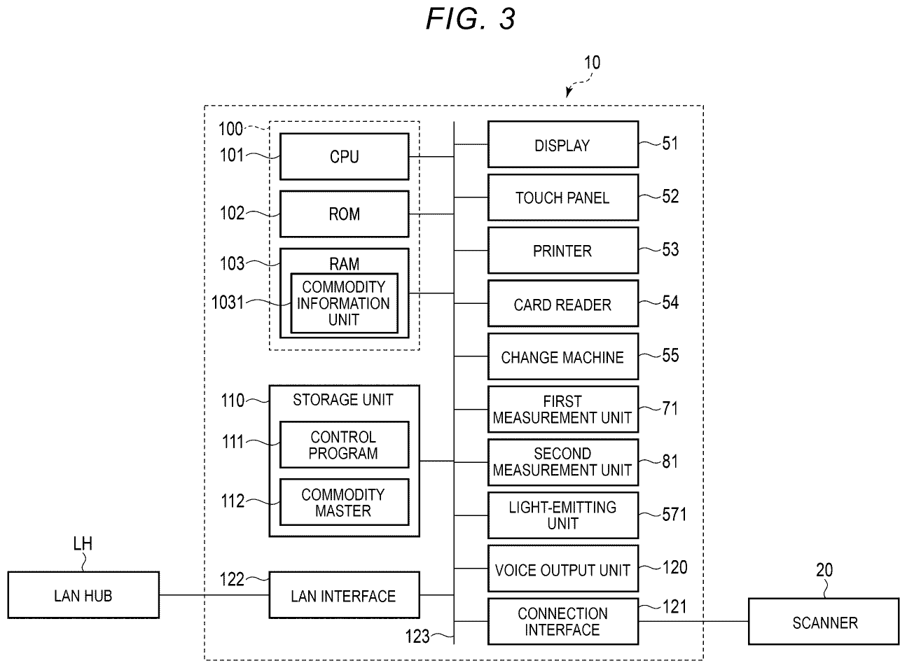

As illustrated in FIG. 2, the POS terminal 10 includes a body unit 50, a first loading stand 70, and a second loading stand 80. The body unit 50 includes a display 51 and a touch panel 52 in the upper portion and houses a printer 53, a card reader 54, and a change machine 55 inside (see FIG. 3 for each unit).

The display 51 is a display device such as a liquid crystal display (LCD) and displays various types of information to an operator (user). For example, the display 51 displays commodity information such as a commodity name and a price of a commodity that has been registered through a registration operation of the customer. The display 51 displays payment information such as a total amount due and a change due amount for the transaction during a payment operation of the customer.

The touch panel 52 is installed on the surface of the display 51 and receives user inputs according to a touched position and sends inputs to a control unit 100 (see FIG. 3) of the POS terminal 10. The customer or a manager (either of which may be referred to as an operator or a user) using the POS terminal 10 can operate the touch panel 52 by touching any of various buttons, icons, or operational keys displayed on the display 51.

As illustrated in FIG. 2, a reading window 230 for the scanner 20, a dispensing port 531 for a receipt printed by the printer 53, and a card insertion port 541 for the card reader 54 are formed below the display 51 in a direction facing the customer (or user).

The reading window 230 permits imaging (photographing) the exterior of a commodity with the scanner 20. A customer performs s a commodity registration by holding a commodity to be purchased to the reading window 230. The customer may generally hold the commodity up to the reading window 230 while changing orientation or positioning of the commodity until the self-service POS system 1 successfully performs the commodity registration and a registration completion sound (tone) is generated.

The dispensing port 531 is an opening through which a receipt printed by the printer 53 is discharged. On the receipt, information (payment process information) related to a completed (settled) transaction is printed. The POS terminal 10 may be set to issue an electronic receipt instead of a paper receipt in some cases.

The card insertion port 541 is an opening through which a credit card or the like to be read by the card reader 54 is inserted. When the customer performs settlement with a credit card or the customer performs reading of a store membership card or the like, the card is inserted from the card insertion port 541.

In the body unit 50, a coin insertion port 551, a coin discharge port 552, a coin reception tray 553, a bill insertion port 554, and a bill discharge port 555 are formed to correspond to a position of the change machine 55 accommodated inside.

The coin insertion port 551 is an opening through which the customer inserts coins for settlement. The coins inserted into the coin insertion port 551 are then held in the change machine 55. The coin discharge port 552 is an opening through which coins can be dispensed from the change machine 55. The coin discharge port 552 discharges change or returns coins not accepted for payment by the change machine 55. The coin reception tray 553 is a tray that receives coins discharged from the coin discharge port 552. The bill insertion port 554 is an opening through which a customer inputs bills for settlement. The bills inserted into the bill insertion port 554 are then held in the change machine 55. The bill discharge port 555 is an opening through which bills can be discharged from the change machine 55.

The first loading stand 70 is a stand on which a shopping basket containing commodities to be purchased by a customer can be placed. The first loading stand 70 includes a first measurement unit 71. The first measurement unit 71 measures a total weight of the shopping basket placed on the first loading stand 70 and the commodities contained in the shopping basket.

The second loading stand 80 is a stand on which a shopping basket or the like for containing already scanned commodities (registered commodities) which have been transferred from a shopping basket placed on the first loading stand 70 can be placed. The second basket loading stand 80 includes a second measurement unit 81, a pair of support rods 82, and a temporary stand 83.

The second measurement unit 81 measures a total weight of items placed on the second loading stand 80. For example, if a shopping basket is placed on the second loading stand 80, the total weight of the basket and the commodities contained in the basket is measured. Or if items are placed in a shopping bag is placed on the pair of support rods 82, the total weight of the bag and commodities contained in the bag is measured. The support rods 82 are rods on which a shopping bag can be hooked and supported. The support rods 82 facilitate input of commodities into the shopping bag by supporting the shopping bag in an opened state. The temporary stand 83 is a stand on which commodities that might be easily broken or deformed, for example, tofu or eggs, can be temporarily placed. The customer can then place items on the temporary stand 83 into a shopping basket or a shopping bag to avoid breakage or the like.

The customer performs commodity registration by holding a commodity taken from the shopping basket placed on the first loading stand 70 to the reading window 230. Then, the customer places the registered commodities on the second loading stand 80 or in a shopping bag supported by the support rods 82.

The first measurement unit 71 measures weight before and after the commodities are taken out of the shopping basket on the first loading stand 70, and then the control unit 100 (see FIG. 3) recognizes a change in the weight as items are moved. The second measurement unit 81 measures weight before and after the commodities are placed in a shopping basket or a shopping bag on the second loading stand 80, and thus the control unit 100 recognizes a change in the weight as items are placed on the second loading stand 80. Based on whether the changes in the weight at first loading stand 70 are equal to (or substantially match) those at the second loading stand 80, the control unit 100 can detect whether all the commodities to be purchased by the customer have been appropriately subjected to the commodity registration process.

The body unit 50 includes a columnar pole 57 extending upward. A light-emitting unit 571 that emits light when calling a store staff member (or a manager of the POS terminal 10) is provided at an upper tip end of the pole 57.

### Hardware Configuration of POS Terminal

Next, a hardware configuration of the POS terminal 10 will be described with reference to FIG. 3. FIG. 3 is a block diagram illustrating aspects of a hardware configuration of the POS terminal 10.

The POS terminal 10 includes a control unit 100, a storage unit 110, a display 51, a touch panel 52, a printer 53, a card reader 54, a change machine 55, a first measurement unit 71, a second measurement unit 81, a light-emitting unit 571, a voice output unit 120, a connection interface 121, and a LAN interface 122. The control unit 100, the storage unit 110, the display 51, the touch panel 52, the printer 53, the card reader 54, the change machine 55, the first measurement unit 71, the second measurement unit 81, the light-emitting unit 571, the voice output unit 120, the connection interface 121, and the LAN interface 122 are connected to each other via a bus 123 or the like.

The control unit 100 includes a central processing unit (CPU) 101, a read only memory (ROM) 102, and a random access memory (RAM) 103. The CPU 101, the ROM 102, and the RAM 103 are connected to each other via the bus 123.

The CPU 101 controls the entire POS terminal 10. The ROM 102 stores various types of data and programs. The RAM 103 is used as a work area of the CPU 101. The control unit 100 performs various control processes for the POS terminal 10, for example, by having the CPU 101 execute a control program 111 from the storage unit 110 in RAM 103.

The RAM 103 includes a commodity information unit 1031. The commodity information unit 1031 stores commodity information read from a commodity master 112 based on a commodity code acquired from the scanner 20. The commodity registration is performed by storing (registering) commodity information in the commodity information unit 1031. The commodity information stored in the commodity information unit 1031 includes such things as a commodity code, a commodity name, a price, and the like. The commodity information unit 1031 stores commodity information related to a transaction and clears the commodity information after a payment process for the transaction is completed.

The storage unit 110 can be a storage medium such as a hard disk drive (HDD) or a flash memory and stores storage content even when power is turned off. The storage unit 110 stores the control program 111 and the commodity master 112.

The control program 111 provides instructions for implementing functions for receiving a commodity code from the scanner 20, performing the commodity registration based on the received commodity code, and performing the setting of various operation modes of the commodity information registration system RS in response to an operation of a manager. The control program 111 may be stored in the ROM 102 instead of being stored in the storage unit 110.

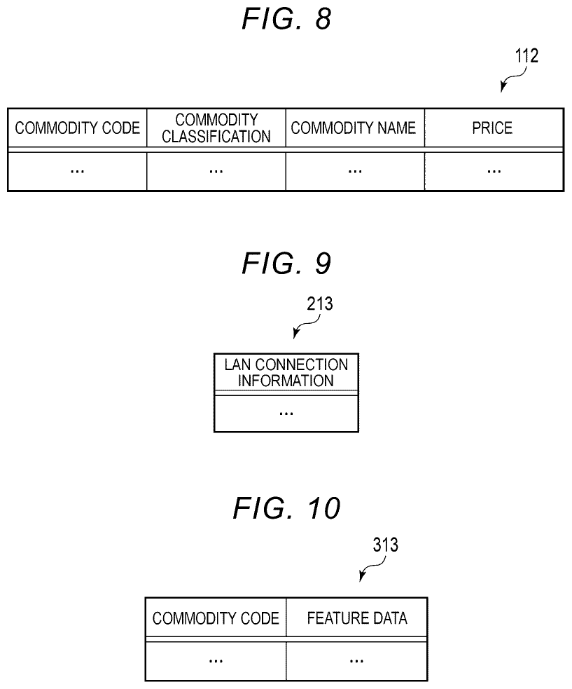

The commodity master 112 is a master file that stores commodity information regarding commodities available in a store. Since the commodities available in the store are changed daily, the commodity master 112 may be appropriately updated by a store server or the like connected via the LAN interface 122. FIG. 8 is a diagram illustrating a data configuration of the commodity master 112. The commodity master 112 includes commodity codes, commodity classification associated with the commodity codes, commodity names, and prices.

The commodity code is information identifying a commodity. The commodity classification in this context is information for classifying commodities by type or general group in the store. The commodity name is information indicating a name of the commodity. The price is information indicating the price (unit price) of the commodity. The commodity master 112 may include other pieces of information in association with the commodity codes.

Referring to FIG. 3, a hardware configuration of the POS terminal 10 will be described. The display 51 and the touch panel 52 have the above-described configurations and functions.

The printer 53 can be, for example, a thermal printer. The printer 53 prints information regarding a transaction or the like on a rolled receipt sheet and dispenses the receipt from the dispensing port 531.

The card reader 54 reads credit information necessary for settlement from a credit card inserted from the card insertion port 541. The card reader 54 reads membership information for specifying a member from a medium such as a membership card or a point card inserted from the card insertion port 541. The card reader 54 may magnetically read information from the card or may be an integrated circuit (IC) card reader that reads information from an IC card embedded with an IC chip.

The change machine 55 receives bills and coins paid in by a customer and dispenses change as necessary when the customer settles a purchase price in cash. The bills are inserted from the bill insertion port 554 and the coins are inserted from the coin insertion port 551. Bills for change are discharged from the bill discharge port 555 and coins for change are discharged from the coin discharge port 552.

The first measurement unit 71, the second measurement unit 81, and the light-emitting unit 571 have the above-described configurations and functions. The voice output unit 120 generates a sound as necessary to notify a customer of information. For example, the voice output unit 120 outputs an announcement sound or tone indicating completion of the commodity registration. The voice output unit is an example of an announcement unit.

The connection interface 121 is an interface for communication with the scanner 20 via the LAN or the USB. The control unit 100 transmits and receives information (data) to and from the scanner 20 via the LAN or the USB through the connection interface 121. For example, the control unit 100 receives a commodity code from the scanner 20 via the LAN or the USB through the connection interface 121. For example, the control unit 100 transmits data of an operation mode selected in response to an operation of the manager to the scanner 20 via the LAN or the USB through the connection interface 121.

The LAN interface 122 is an interface for communication with the LAN hub LH via the LAN. The control unit 100 transmits and receives information (data) to and from the LAN hub LH via the LAN through the LAN interface 122. For example, the control unit 100 transmits and receives the commodity master 112 to and from the server 40 via the LAN through the LAN hub LH and the wireless router WR.

The LAN interface 122 is also an interface for communication with an external apparatus such as a store server or the like managed in a store. The control unit 100 transmits and receives information to and from an external apparatus via the LAN through the LAN interface 122.

### Hardware Configuration of Scanner

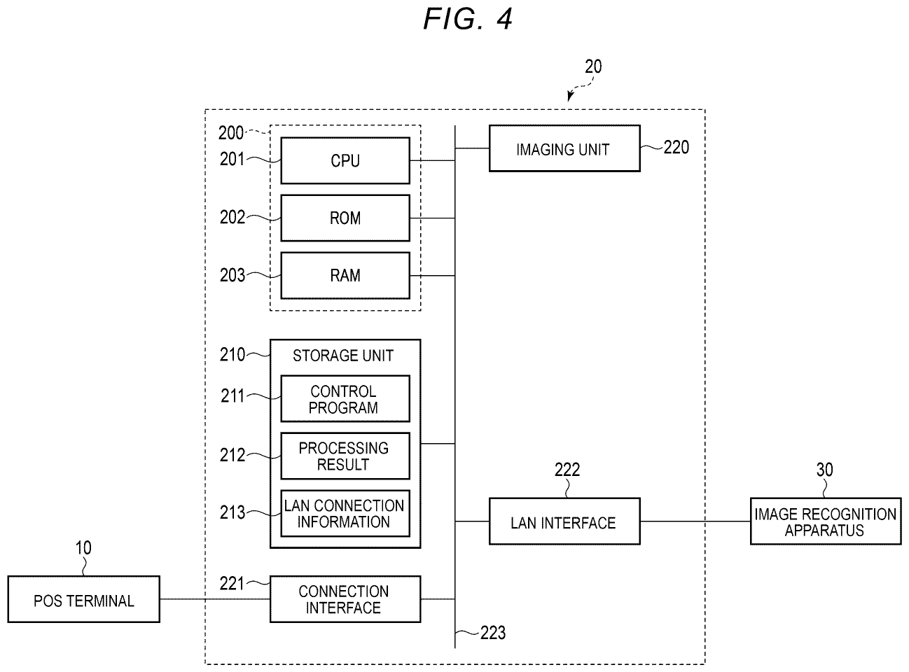

Next, a hardware configuration of the scanner 20 will be described with reference to FIG. 4. FIG. 4 is a block diagram illustrating aspects of a hardware configuration of the scanner 20.

The scanner 20 acquires a commodity image that is a captured image obtained by imaging a commodity to be purchased by the customer. The scanner 20 attempts to detect a commodity barcode in the commodity image (that is, the barcode attached to or on the imaged commodity) and decode the detected commodity barcode when possible. A decoding result from the commodity barcode provides the commodity code stored in the commodity barcode. The scanner 20 transmits the commodity image to the image recognition apparatus 30 via the LAN.

The scanner 20 includes a control unit 200, a storage unit 210, an imaging unit 220, a connection interface 221, and a LAN interface 222. The control unit 200, the storage unit 210, the imaging unit 220, the connection interface 221, and the LAN interface 222 are connected to each other through a bus 223 or the like.

The control unit 200 includes a CPU 201, a ROM 202, and a RAM 203. The CPU 201, the ROM 202, and the RAM 203 are connected to each other via the bus 223.

The CPU 201 controls the entire scanner 20. The ROM 202 stores various types of data and various programs. The RAM 203 is used as a work area of the CPU 201. The control unit 200 performs various control processes for the scanner 20 by having the CPU 201 execute a control program 211 from the storage unit 210 in the RAM 203.

The storage unit 210 can be a storage medium such as an HDD or a flash memory and stores storage content even when power is turned off. The storage unit 210 stores the control program 211, a processing result 212, and LAN connection information 213.

The control program 211 provides instructions for implementing functions of causing the imaging unit 220 to start imaging in response to reception of a transaction start signal from the POS terminal 10, storing a frame image (captured image) obtained by imaging a commodity by the imaging unit 220 in the RAM 203, acquiring a frame image (a commodity image that is a captured image) stored in the RAM 203, detecting a commodity barcode included in the commodity image, decoding the commodity barcode, transmitting the commodity image to the image recognition apparatus 30, receiving an image recognition result from the image recognition apparatus 30, merging the decoding result and the image recognition result, transmitting a commodity code (after the merging) to the POS terminal 10, stopping imaging by the imaging unit 220 in response to reception of a registration completion signal from the POS terminal 10, and the like. The control program 211 may be stored in the ROM 202 instead of being stored in the storage unit 210.

The processing result 212 can be a decoding result obtained by decoding a commodity barcode, an image recognition result obtained by the image recognition apparatus 30, or a merged result obtained from the decoding result and the image recognition result. The merged result includes a commodity barcode included in the commodity image or a commodity code of a commodity in the commodity image.

The LAN connection information 213 is information indicating a connection state of a LAN cable to a port of the LAN interface 222. FIG. 9 is a diagram illustrating an example of the LAN connection information 213. The LAN connection information 213 includes information indicating whether the LAN cable is connected to each port or information indicating a set link speed in a connection state.

The imaging unit 220 can be, for example, by a color CCD image sensor, a color CMOS image sensor, or the like. The imaging unit 220 outputs a commodity image that is a captured image obtained by imaging a commodity over the reading window 230 under the control of the control unit 200. For example, the imaging unit 220 captures a video with a predetermined frame rate (for example, 30 fps). The imaging unit 220 stores sequentially captured frame images in the RAM 203. The frame images (commodity images) stored in the RAM 203 are used for identifying commodity codes of commodities depicted in the frame images.

The connection interface 221 is an interface for communication with the POS terminal 10 via the LAN or the USB. The control unit 200 transmits and receives information (data) to and from the POS terminal 10 via the LAN or the USB through the connection interface 221.

The LAN interface 222 is an interface for communication with the image recognition apparatus 30 via the LAN. The control unit 200 transmits and receives information (data) to and from the image recognition apparatus 30 via the LAN through the LAN interface 222.

The control unit 200 detects a commodity barcode included in a frame image (commodity image) stored in the RAM 203 and decodes the commodity barcode to acquire the commodity code stored in the commodity barcode. The control unit 200 transmits a frame image (commodity image) stored in the RAM 203 to the image recognition apparatus 30 through the LAN interface 222 and receives an image recognition result (commodity code) by the image recognition apparatus 30 from the image recognition apparatus 30. The control unit 200 merges the decoding result and the image recognition result, identifies the commodity barcode included in the commodity image or obtains the commodity code of the commodity depicted in the commodity image, and transmits the specified commodity code to the POS terminal 10 through the connection interface 221.

### TCP Client Function

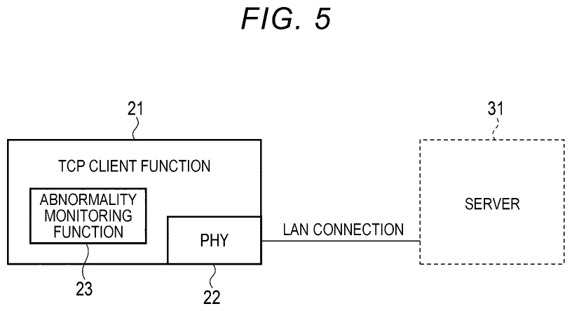

FIG. 5 is a diagram illustrating a relation between a TCP client function mounted on the LAN interface 222 and a server.

As illustrated in FIG. 5, the LAN interface 222 includes a TCP client function 21 in conformity with TCP. The client function 2 includes a communication module 22 in a physical layer (PHY). The communication module 22 performs negotiation or data communication with a server 31 when a connector of the LAN cable is connected to a LAN port. The communication module 22 performs negotiation with the server 31 side and sets a link mode (link speed) to start communication in the connection state of the LAN cable. The negotiation is performed by interruption at a moment at which the LAN cable is connected to a port.

The client function 21 has an abnormality monitoring function 23. The abnormality monitoring function 23 monitors whether an abnormality occurs in a communication path between the communication model 22 and the server 31, and transmits a signal indicating the abnormality when the abnormality is detected.

Here, a case in which the image recognition apparatus 30 is the server 31 will be assumed. However, an exemplary embodiment is not limited thereto. For example, the POS terminal 10 may serve as the server 31. A relation between the server 31 and a client may be switched to a relation between the image recognition apparatus 30 and the scanner 20 or may be switched to a relation between the POS terminal 10 and the scanner 20.

### Hardware Configuration of Image Recognition Apparatus

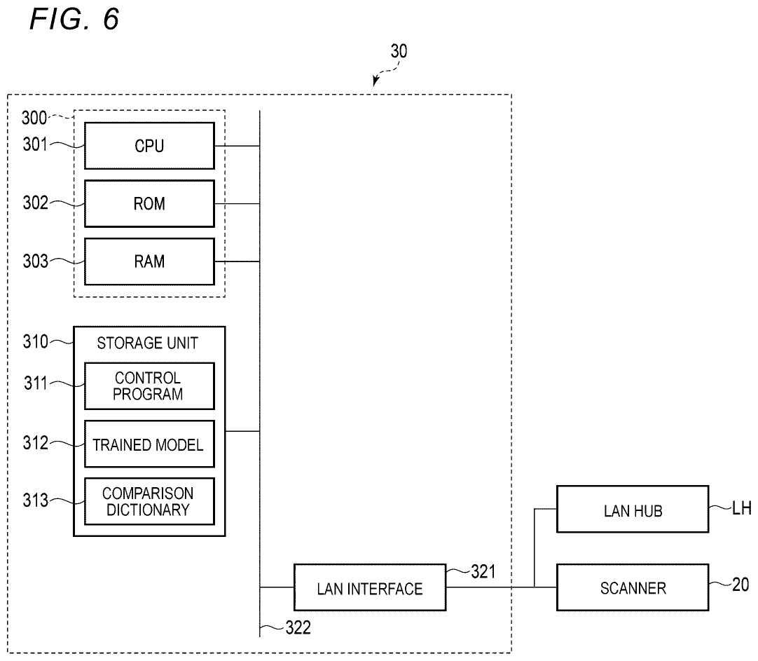

Next, a hardware configuration of the image recognition apparatus 30 will be described with reference to FIG. 6. FIG. 6 is a block diagram illustrating aspects of a hardware configuration of the image recognition apparatus 30.

The image recognition apparatus 30 receives the commodity image that is a captured image from the scanner 20 via the LAN. The image recognition apparatus 30 starts image recognition by receiving the captured image from the scanner 20 and stops the image recognition by not receiving the captured image from the scanner 20. The image recognition apparatus 30 performs the image recognition on the commodity image included in the received captured image. That is, the image recognition apparatus 30 acquires the commodity code of the commodity depicted in the commodity image based on feature data in the commodity image. The image recognition apparatus 30 transmits an image recognition result to the scanner 20 via the LAN. The image recognition apparatus 30 transmits the commodity image, or the commodity image and the commodity code to the server 40 via the LAN. The image recognition apparatus 30 receives the updated trained model and comparison dictionary from the server 40 via the LAN and updates the currently stored trained model and comparison dictionary.

The image recognition apparatus 30 includes a control unit 300, a storage unit 310, and a LAN interface 321. The control unit 300, the storage unit 310, and the LAN interface 321 are connected to each other via a bus 322 or the like.

The control unit 300 includes a CPU 301, a ROM 302, and a RAM 303. The CPU 301, the ROM 302, and the RAM 303 are connected to each other via the bus 322.

The CPU 301 controls the entire image recognition apparatus 30. The ROM 302 stores various types of data and programs. The RAM 303 is used as a work area of the CPU 301. The control unit 300 performs various control processes of the image recognition apparatus 30, for example, by causing the CPU 301 to operate according to a control program 311.

The storage unit 310 can be a storage medium such as an HDD or a flash memory and stores storage content even when power is turned off. The storage unit 310 stores the control program 311, a trained model 312, and a comparison dictionary 313.

The control program 311 provides instructions for implementing functions of receiving a commodity image that is a captured image from the scanner 20, performing image recognition on the commodity image, determining whether the image recognition is successful, transmitting an image recognition result to the scanner 20, receiving the commodity code as a decoding result from the scanner 20, determining whether the commodity image is to be used for additional learning, transmitting the commodity image alone or the commodity image and the commodity code to the server 40, receiving the updated trained model and the updated comparison dictionary from the server 40, updating the currently stored trained model with the updated trained model, and updating the currently stored comparison dictionary with the updated comparison dictionary. The control program 311 may be stored in the ROM 302 instead of being stored in the storage unit 310.

The trained model 312 is an image recognition model for performing image recognition on a commodity image (a picture of a commodity). The trained model 312 is trained through machine learning and may be updated or adapted by additional machine learning.

The comparison dictionary 313 is a data table in which a particular commodity (commodity code) is associated with feature data related to the exterior of the commodity (e.g., the packaged commodity). FIG. 10 is a diagram illustrating a data configuration of the comparison dictionary 313. The comparison dictionary 313 includes a commodity code and feature data associated with the commodity code. Multiple instances of feature data may be associated with one commodity code in some examples. A commodity code used in the comparison dictionary 313 is the same as the commodity code in the commodity master 112.

The feature data may be, for example, data obtained by parameterizing visible features of the exterior of an item (commodity), such as a package shape, a surface color a surface texture, characteristic image patterns, or surface unevenness (roughness) on the commodity. The control unit 300 acquires the feature data from the commodity image, compares the acquired feature data to entries in the comparison dictionary, and identifies the commodity code associated in the comparison dictionary with the feature data closest to matching that from the commodity image. In other words, based on the feature data acquired from the commodity image, the control unit 300 acquires a commodity code of the commodity in the commodity image from among entries for commodities stored in advance in the comparison dictionary 313.

Referring back to FIG. 6, the hardware configuration of the image recognition apparatus 30 will be further described.

The LAN interface 321 is an interface for communication with the scanner 20 and the LAN hub LH. The control unit 300 transmits and receives information (data) to and from the scanner 20 and the LAN hub LH through the LAN interface 321.

For example, the control unit 300 receives a frame image (a commodity image) from the scanner 20 through the LAN interface 321. The control unit 300 acquires the commodity code of the commodity depicted in the commodity image and transmits the acquired commodity code to the scanner 20 through the LAN interface 321.

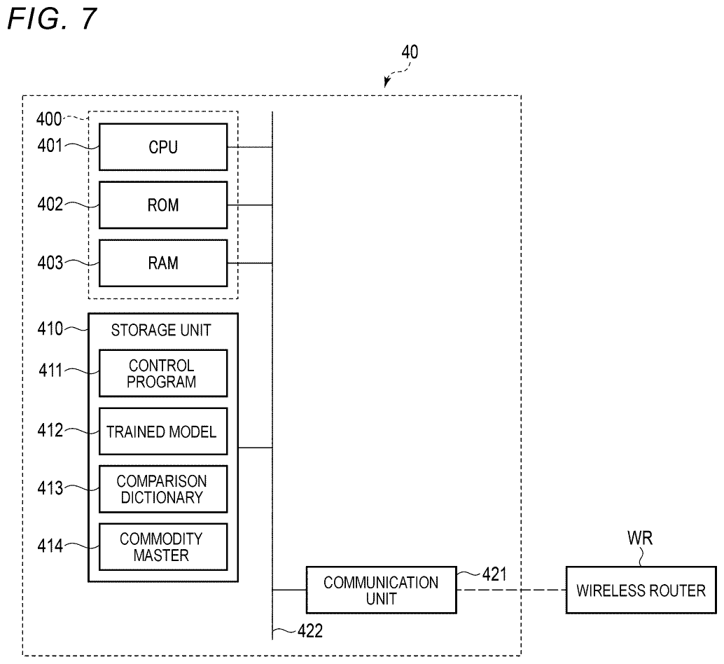

The control unit 300 transmits either a commodity image to be subjected to image recognition or the commodity image and the commodity code obtained as the decoding result from the scanner 20 to the server 40 through the LAN interface 321 as necessary. The control unit 300 may receive an updated trained model 412 (see FIG. 7) and an updated comparison dictionary 413 (see FIG. 7) from the server 40 through the LAN interface 321. The control unit 300 then updates the currently stored trained model 312 with the updated trained model 412. Likewise, the control unit 300 updates the currently stored comparison dictionary 313 with the updated comparison dictionary 413.

### Hardware Configuration of Server

Next, a hardware configuration of the server 40 will be described with reference to FIG. 7. FIG. 7 is a block diagram illustrating aspects of a hardware configuration of the server 40.

The server 40 receives commodity images and commodity codes transmitted from the image recognition apparatus 30 and accumulates the commodity images and commodity codes. The server 40 performs additional learning associated with the trained model for commodity image recognition using the accumulated commodity images and corresponding commodity codes and updates the trained model and the comparison dictionary when appropriate. The server 40 may then transmit the updated trained model and the updated comparison dictionary to the image recognition apparatus 30. The server 40 manages a commodity master. The server 40 may also receive payment process information from the POS terminal 10 and update the commodity master based on the received payment process information (sales information). The server 40 transmits a commodity master appropriate for the POS terminal 10 to each POS terminal 10.

The server 40 includes a control unit 400, a storage unit 410, and a communication unit 421. The control unit 400, the storage unit 410, and the communication unit 421 are connected to each other via a bus 422 or the like.

The control unit 400 includes a CPU 401, a ROM 402, and a RAM 403. The CPU 401, the ROM 402, and the RAM 403 are connected to each other via the bus 422.

The CPU 401 controls the entire server 40. The ROM 402 stores various types of data and programs. The RAM 403 is used as a work area of the CPU 401. The control unit 400 performs various control processes of the server 40, for example, by causing the CPU 401 to execute a control program 411 in the RAM 403.

The storage unit 410 can be a storage medium such as an HDD or a flash memory and stores storage content even when power is turned off. The storage unit 410 stores the control program 411, a trained model 412, a comparison dictionary 413, and a commodity master 414.

The control program 411 provides instructions for implementing functions of receiving the commodity images and the commodity codes from the image recognition apparatus 30, accumulating the commodity images and the commodity codes, updating the trained model 412 through additional learning, updating the comparison dictionary 413, transmitting the updated trained model 412 and the updated comparison dictionary 413 to the image recognition apparatus 30, receiving the payment process information from the POS terminal 10, managing the commodity master 414, transmitting the commodity master 414 to the POS terminal 10, and transmitting the accumulated commodity images to an external apparatus as necessary. The control program 411 may be stored in the ROM 402 instead of being stored in the storage unit 410.

The trained model 412 can be trained through machine learning to perform image recognition on the commodity image. Specifically, in this context, the trained model 412 is an image recognition model for identifying a commodity depicted in a commodity image and providing the commodity code of the identified commodity. The commodity is identified by acquiring the feature data in the commodity image and comparing the acquired feature data with entries in the comparison dictionary 413.

The comparison dictionary 413 is a data table managed by associating the commodity code of a commodity with feature data corresponding to the exterior of the commodity. In general, comparison dictionary 413 is similar to the comparison dictionary 313 stored in an image recognition apparatus 30. However, the comparison dictionary 413 comprise may the comparison dictionaries 313 (or equivalents thereof) of several different image recognition apparatuses 30 in combination. The server 40 may transmit a particular comparison dictionary 313 as appropriate to each image recognition apparatus 30 individually.

The commodity master 414 includes entries for each commodity code, along with a commodity classification, a commodity name, and a price associated with each commodity code. In general, commodity master 414 is similar to a commodity master 112 stored in a POS terminal 10. However, the commodity master 414 may comprise the commodity masters 112 (or equivalents thereof) of several different POS terminals 10. The server 40 manages the commodity master 414 based on the payment process information received from the POS terminals 10. For example, the server 40 updates presently stocked numbers in the commodity master 414 based on the payment process information. The server 40 transmits the commodity master 112 appropriate for each POS terminal 10.

The communication unit 421 is an interface for communication with the wireless router WR. The control unit 400 transmits and receives information (data) to and from the wireless router WR through the communication unit 421.

For example, the control unit 400 receives a commodity image and an image recognition result from the image recognition apparatus 30 through the communication unit 421 and accumulates the commodity images and the image recognition results. The control unit 400 performs additional learning associated with the trained model 412 using the accumulated commodity image and image recognition result and then updates the trained model 412 and the comparison dictionary 413. The control unit 400 may then transmit the updated trained model and the updated comparison dictionary to the image recognition apparatus 30 through the communication unit 421. The control unit 400 may also transmit an accumulated commodity image (or images) to an external apparatus as necessary.

The server 40 receives the payment process information from the POS terminal 10 through the communication unit 421. The server 40 manages the commodity master based on the received payment process information. The server 40 transmits a commodity master appropriate for each POS terminal 10 through the communication unit 421.

### Functional Aspects of POS Terminal

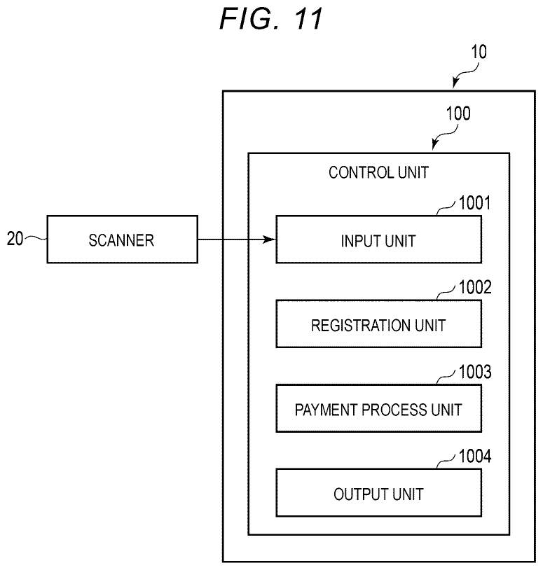

Next, functional aspects of the POS terminal 10 will be described with reference to FIG. 11. FIG. 11 is a block diagram illustrating functional aspects of the control unit 100 of the POS terminal 10.

The control unit 100 includes an input unit 1001, a registration unit 1002, a payment process unit 1003, and an output unit 1004. The control unit 100 functions as the input unit 1001, the registration unit 1002, the payment process unit 1003, and the output unit 1004 by causing the CPU 101 to operate according to a control program stored in the ROM 102 or the storage unit 110. The functions may each be implemented via hardware such as a dedicated circuit.

Various types of information are input to the input unit 1001 from the scanner 20, the touch panel 52, the card reader 54, the first measurement unit 71, the second measurement unit 81, and the like. For example, the commodity code is input from the scanner 20 to the input unit 1001.

Information based on an operation of the touch panel 52 is input to the input unit 1001. For example, transaction start information for announcing the start of a transaction is input to the input unit 1001. Registration completion information indicating completion of the commodity registration in a transaction is input to the input unit 1001.

The registration unit 1002 performs the commodity registration for the commodities to be purchased by the customer in response to operations of the customer. In other words, the registration unit 1002 registers information regarding the commodities identified with the commodity identification information input to the input unit 1001. Specifically, the registration unit 1002 reads the commodity information from the commodity master 112 based on the commodity codes input to the input unit 1001. Then, the registration unit 1002 stores the read commodity information in the commodity information unit 1031. The commodity information is information including a commodity code, a commodity name, and a price.

The payment process unit 1003 performs a payment process for transaction settlement according to the prices of the commodities registered by the registration unit 1002. Specifically, the payment process unit 1003 performs a process of calculating a total amount (transaction amount) for the registered commodities, a change calculating due amount, displaying various types of information, and dispensing a receipt. The payment process unit 1003 can perform the payment process necessary for settlement when a customer desires a cashless settlement such as credit settlement or 2-dimensional code settlement.

The output unit 1004 provides various types of information to the scanner 20, the printer 53, the change machine 55, the light-emitting unit 571, the voice output unit 120, or the like. For example, when transaction start information is input to the input unit 1001, the output unit 1004 outputs an imaging start signal for instructing the scanner 20 to start imaging (begin acquiring pictures). When registration completion information is input to the input unit 1001, the output unit 1004 outputs an imaging stop signal for instructing the scanner 20 to stop the imaging.

When the registration unit 1002 completes the commodity registration of one commodity, the output unit 1004 outputs a control signal to the voice output unit 120 for causing an announcement sound to be output. The output unit 1004 functions as an announcement unit that indicates a successful registration by the registration unit 1002 in conjunction with the voice output unit 120. In some examples, the voice output unit 120 may be included in the scanner 20. In such a case, the voice output unit 120 may issue an announcement sound as soon as the scanner 20 identifies a commodity code.

### Functional Aspects of Scanner

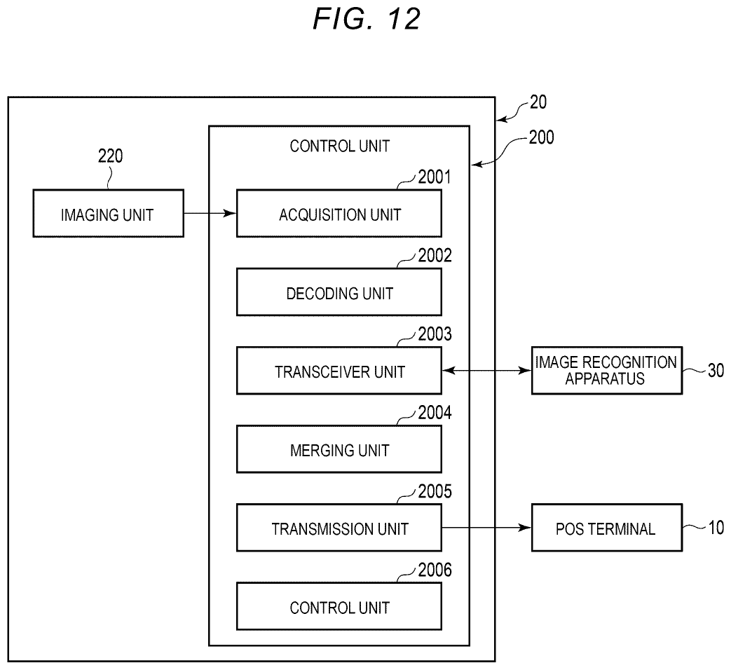

Next, functional aspects of the scanner 20 will be described with reference to FIG. 12. FIG. 12 is a block diagram illustrating functional aspects of the control unit 200 of the scanner 20.

The control unit 200 includes an acquisition unit 2001, a decoding unit 2002, a transceiver unit 2003, a merging unit 2004, and a transmission unit 2005. The control unit 200 functions as the acquisition unit 2001, the decoding unit 2002, the transceiver unit 2003, the merging unit 2004, and the transmission unit 2005 when the CPU 201 operates according to a control program stored in the ROM 202 or the storage unit 210. These functions may be implemented with hardware such as a dedicated circuit.

The acquisition unit 2001 acquires one frame image (captured image) as a commodity image from a video captured by the imaging unit 220. The acquisition unit 2001 stores the acquired commodity image in the RAM 203. For example, the acquisition unit 2001 acquires all or some of a plurality of frame images sequentially captured by the imaging unit 220 as candidates for the commodity image, stores all or some of the acquired frame images in the RAM 203, and selects a commodity image from all or some of the stored frame images.

The acquisition unit 2001 acquires various other types of information. For example, the acquisition unit 2001 acquires an imaging start signal and an imaging stop signal from the POS terminal 10. The acquisition unit 2001 detects the start of an operation by the customer (that is, use of the customer) by acquiring the imaging start signal from the POS terminal 10 and detects the completion of an operation by the customer (that is, non-use or ending of use by the customer) by acquiring the imaging stop signal from the POS terminal 10. When the acquisition unit 2001 acquires the imaging start signal from the POS terminal 10, the imaging unit 220 starts imaging and the acquisition unit 2001 acquires a captured image from the imaging unit 220. When the acquisition unit 2001 acquires the imaging stop signal from the POS terminal 10, the imaging unit 220 stops the imaging and the acquisition unit 2001 stops acquiring the captured image.

The decoding unit 2002 detects a commodity barcode included in a commodity image (a captured image) acquired by the acquisition unit 2001 and extracts the commodity barcode from the commodity image. The decoding unit 2002 decodes the extracted commodity barcode. The decoding unit 2002 acquires the commodity code stored in the commodity barcode as a decoding result.

The transceiver unit 2003 transmits the commodity image acquired by the acquisition unit 2001 to the image recognition apparatus 30. The image recognition apparatus 30 performs image recognition on the received commodity image and transmits an image recognition result (a commodity code of a commodity in the commodity image) to the scanner 20. The transceiver unit 2003 receives an image recognition result from the image recognition apparatus 30. The transceiver unit 2003 transmits a decoding result (the commodity code stored in the commodity barcode) to the image recognition apparatus 30.

The merging unit 2004 merges the decoding result (the commodity code from the commodity barcode) and the image recognition result (the commodity code of the commodity in the commodity image). That is, the merging unit 2004 selects one commodity code from the decoding result and the image recognition result. A merged result includes the commodity code from the commodity barcode or the commodity code from the image recognition process.

The merging unit 2004 obtains the commodity code of the image recognition result as the merged result when the decoding result cannot be obtained. As a situation in which the decoding result cannot be obtained, there are cases such as where the customer does not correctly hold the commodity barcode in front of the imaging unit 220 of the scanner 20, or where the commodity barcode is bent, folded, or obscured.

When both the decoding result and the image recognition result are obtained and match each other, the merging unit 2004 obtains the matched commodity code as the merged result. When both the decoding result and the image recognition result are obtained but do not match each other, the commodity code of the decoding result with high reliability is obtained as the merged result.

The transceiver unit 2005 transmits the commodity code of the merged result to the POS terminal 10 through the connection interface 221.

The control unit 2006 has the following various functions that are functions for performing control according to connection or non-connection of the LAN cable to the LAN interface 222.

For example, the control unit 2006 has a function of disabling the abnormality monitoring function 23 so that an operation mode of the standalone client is not hindered when the LAN cable is not connected to the LAN interface 222 and enabling the abnormality monitoring function 23 so that communication in a client operation mode (in which the client cooperates with the server) is performed without problem while being monitored by the abnormality monitoring function 23 when the LAN cable is connected to the LAN interface 222. By such function, an operator does not need to manually turn off (switch a setting of) the abnormality monitoring function 23 so as to not output a detection of an abnormality when the LAN cable is not connected to the LAN interface 222. When the LAN cable is connected to the LAN interface 222, the operation of the abnormality monitoring function 23 is normal. Therefore, whenever an abnormality occurs in a communication path, the abnormality can be detected reliably.

The control unit 2006 has a function of disabling the abnormality monitoring function 23 after the system is started and the LAN interface 222 is initialized if the LAN cable is not connected to the LAN interface. Such function prevents the abnormality monitoring function 23 from entering a state in which an abnormality would be detected immediately after the LAN interface 222 is initialized with the LAN cable disconnected.

The control unit 2006 has a function of changing the abnormality monitoring function 23 from a disabled state to an enabled state when the LAN cable is connected to the LAN interface 222 after being disconnected. By such function, a standalone client can smoothly transition to a client operation mode (in which the client cooperates with a server) and the abnormality monitoring function 23 can be utilized effectively once the LAN cable is connected to the LAN interface 222.

The control unit 2006 has a function of determining whether the LAN cable is connected to the LAN interface by verifying whether a link speed is set with respect to the LAN interface 222 in the LAN connection information 213. By such function, it is possible to easily verify whether the LAN cable is connected to the LAN interface even when a mechanical connection state of the LAN cable is not otherwise verified.

### Functional Aspects of Image Recognition Apparatus

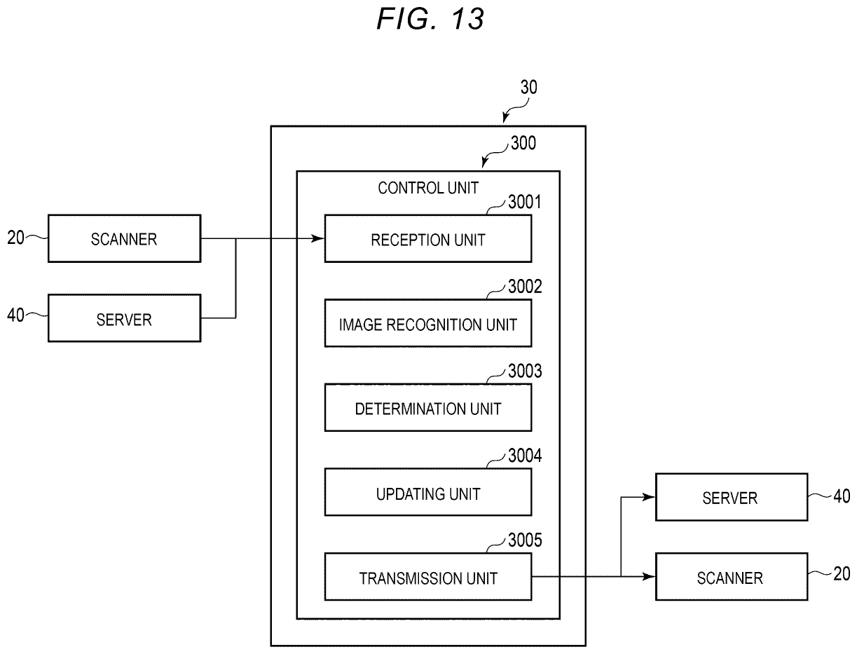

Next, functional aspects of the image recognition apparatus 30 will be described with reference to FIG. 13. FIG. 13 is a block diagram illustrating functional aspects of the control unit 300 of the image recognition apparatus 30.

The control unit 300 includes a reception unit 3001, an image recognition unit 3002, a determination unit 3003, an updating unit 3004, a transmission unit 3005, and a control unit 3006. The control unit 300 functions as the reception unit 3001, the image recognition unit 3002, the determination unit 3003, the updating unit 3004, the transmission unit 3005, and the control unit 3006 when the CPU 301 operates according to a control program stored in the ROM 302 or the storage unit 310. The functions may be implemented with hardware such as a dedicated circuit.

The reception unit 3001 receives a commodity image that is a captured image from the scanner 20 through the LAN interface 321. Specifically, the reception unit 3001 acquires a captured image (for example, images corresponding to 30 frames in one holding operation) obtained by performing an operation of holding a commodity to the imaging unit 220 by the user. The reception unit 3001 stores the received commodity image in the RAM 303.

The image recognition unit 3002 performs image recognition on the commodity image through an image recognition function using the trained model 312. That is, the commodity in the captured image acquired by the reception unit 3001 is recognized. Specifically, the image recognition unit 3002 acquires feature data included in the commodity image, compares the acquired feature data with the comparison dictionary 313, and acquires a commodity code associated with feature data closest to the acquired feature data. The image recognition unit 3002 stores the acquired commodity code in the RAM 303.

The image recognition unit 3002 has a function of detecting an object (object detection function) when the object is in the captured image. The object detection function may be provided separately from the image recognition unit 3002.

The image recognition unit 3002 is a recognition unit that recognizes a commodity in a captured image. Since the decoding unit 2002 in the above-described scanner 20 also recognizes a commodity in a captured image, the decoding unit 2002 can be regarded as an alternative recognition unit (another recognition unit).

The transmission unit 3005 transmits the commodity code (image recognition result) of the image recognition unit 3002 to the transceiver unit 2003 (of the scanner 20) through the LAN interface 321.

The determination unit 3003 checks whether the image recognition unit 3002 successfully performed the image recognition. For example, when a difference between the acquired feature data and the feature data closest to the acquired feature data is less than a predetermined amount, the determination unit 3003 determines that the image recognition was successful. Conversely, when the difference is greater than or equal to the predetermined amount, the determination unit 3003 determines that the image recognition failed. When the determination unit 3003 determines that the image recognition failed, the determination unit 3003 determines that the commodity image that subjected to the failed image recognition is a commodity image to be used for additional learning.

The reception unit 3001 receives the commodity code (decoding result) from the scanner 20 through the LAN interface 321. The reception unit 3001 stores the received commodity code in the RAM 303.

When the determination unit 3003 determines that the commodity image that was subjected to the image recognition is to be used for additional learning, the transmission unit 3005 transmits the commodity image and the corresponding commodity code to the server 40 through the LAN interface 321.

The server 40 performs the additional learning of the trained model 412 using the received commodity image and commodity code, and updates the trained model 412 and the comparison dictionary 413. The server 40 transmits the updated trained model 412 and the updated comparison dictionary 413 to the reception unit 3001 of the image recognition apparatus 30 through the LAN interface 321.

The reception unit 3001 receives the updated trained model 412 and the updated comparison dictionary 413 from the server 40 through the LAN interface 321. The reception unit 3001 stores the received updated trained model 412 and updated comparison dictionary 413 in the RAM 303.

The updating unit 3004 updates the trained model 312 currently stored in the storage unit 310 with the just received updated trained model 412. The image recognition apparatus 30 updates the comparison dictionary 313 currently stored in the storage unit 310 with the just received updated comparison dictionary 413.

### Functional Aspects of Server

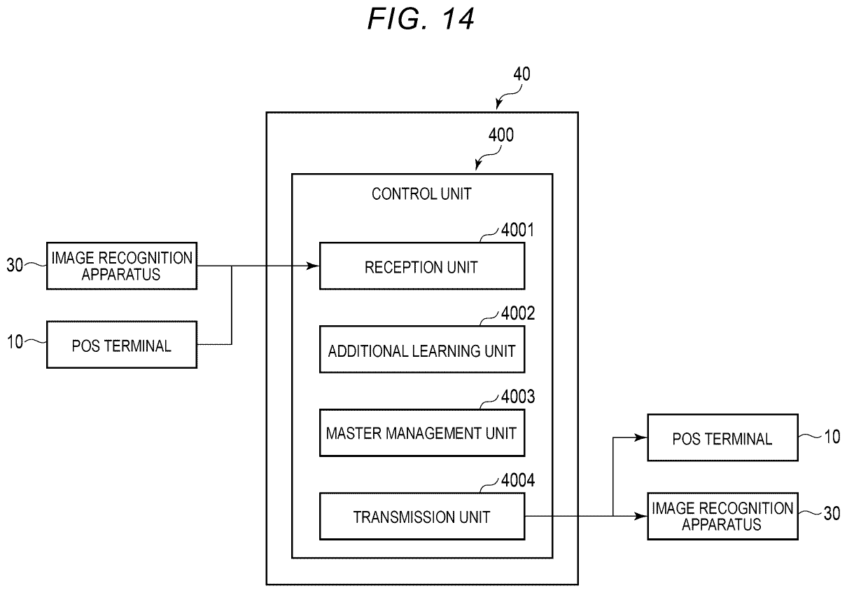

Next, functional aspects of the server 40 will be described with reference to FIG. 14. FIG. 14 is a block diagram illustrating functional aspects of the control unit 400 of the server 40.

The control unit 400 includes a reception unit 4001, an additional learning unit 4002, a master management unit 4003, and a transmission unit 4004. The control unit 400 functions as the reception unit 4001, the additional learning unit 4002, the master management unit 4003, and the transmission unit 4004 by having the CPU 401 execute a control program stored in the ROM 402 or the storage unit 410. The functions may be implemented by hardware such as a dedicated circuit.

The reception unit 4001 receives a commodity image to be used for additional learning and a commodity code of the commodity image from the image recognition apparatus 30 through the communication unit 421. The reception unit 4001 stores the received commodity image and commodity code in the RAM 403. The reception unit 4001 may store and accumulate the received commodity images in the RAM 403 or the storage unit 410 as commodity images to be used for analyzing an image recognition state (event) in the image recognition apparatus 30.

The additional learning unit 4002 performs additional learning related to the trained model 412 and updates the trained model 412 at an appropriate timing, for example, after the commodity images and the commodity codes for the additional learning have been accumulated to some arbitrary extent. After the additional learning for the trained model 412, the additional learning unit 4002 updates the comparison dictionary 413 stored in the storage unit 410.

The transmission unit 4004 then transmits the updated trained model 412 and comparison dictionary 413 as updated by the additional learning unit 4002 as an image file or a compressed file, to the reception unit 3001 of the image recognition apparatus 30 through the communication unit 421.

The reception unit 4001 receives payment process information from a POS terminal 10 through the communication unit 421. The reception unit 4001 stores the received payment process information in the RAM 403.

The master management unit 4003 manages the commodity master 414 stored in the storage unit 410 based on the received payment process information. For example, the commodity master 414 includes a store code for identifying a particular store, a separate commodity master 112 for each store code, and information such as stock availability or remaining item number for each commodity with a commodity code for each store code. The master management unit 4003 updates the commodity master 414, for example, with information regarding the remaining number of commodities based on the received payment process information.

The transmission unit 4004 transmits the commodity master 112 appropriate for a store to the POS terminal(s) 10 of the store through the communication unit 421 based on the commodity master 414 as updated by the master management unit 4003.

### Operation According to Connection or Non-Connection of LAN Cable

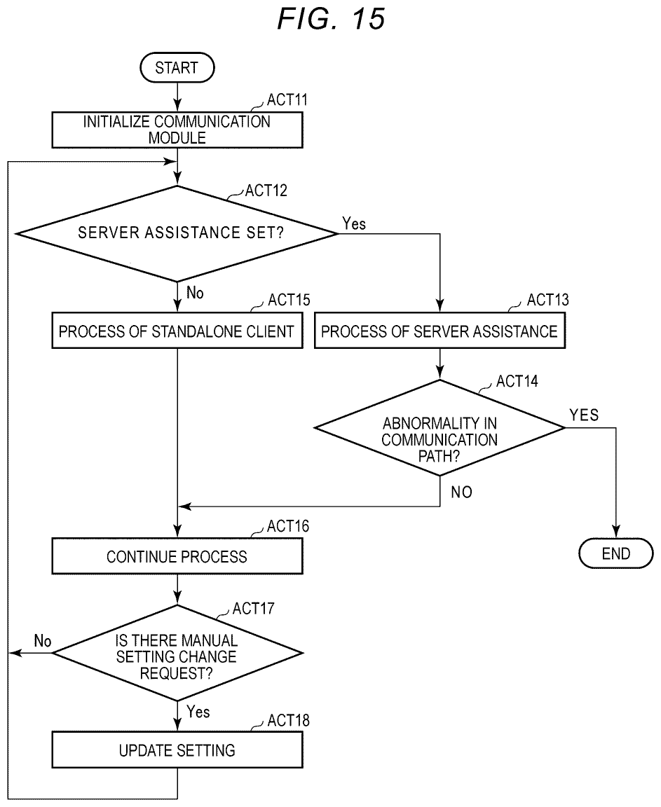

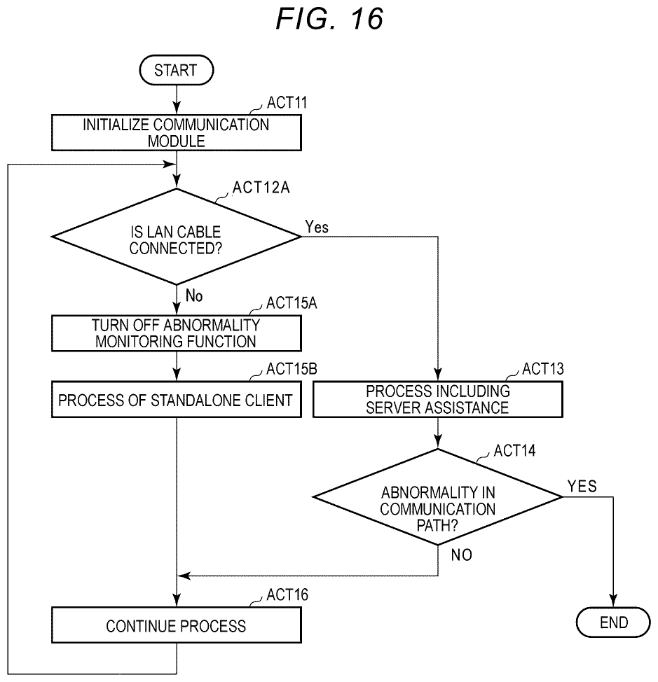

Next, differences between a comparative technique and an embodiment as related to operations according to the connection or non-connection (disconnection) of a LAN cable will be described with reference to FIGS. 15 and 16. Here, it is assumed that the scanner 20 can operate as a client. Differences related to processing related to connection or non-connection of a LAN cable will be mainly described

FIG. 15 is a diagram illustrating an example of operations according to the comparative technique. FIG. 16 is a diagram illustrating operations according to an embodiment.

First, an operation example corresponding to the comparative example of FIG. 15 will be described.

The scanner 20 initializes the communication module 22 (ACT11). However, the scanner 20 does not at this time verify whether the LAN cable is connected, but rather immediately checks whether there is a setting indicating that server assistance is to be utilized or whether the setting indicates that processing is to be performed as a standalone client (ACT12).

For a Yes in ACT12, the server assistance process is performed (ACT13). For a No in ACT12), the process of a standalone client is performed (ACT15). Here, if the abnormality monitoring function 23 has not been appropriately set, the abnormality monitoring function 23 may issue a signal indicating an abnormality has been detected because the LAN cable is not connected.

After the server assistance process (ACT 13) is started, there is a check as to whether the abnormality monitoring function 23 can detect an abnormality in the communication path (ACT14). When the abnormality monitoring function 23 detects an abnormality in the communication path (Yes in ACT14), the process ends. When the abnormality monitoring function 23 does not detect an abnormality in the communication path (No in ACT14), the process proceeds to ACT16.

When the standalone client processing is performed, the process continues onward (ACT16). The scanner 20 next checks whether there is a manual setting change request (ACT17). When there is a setting change request (Yes in ACT17), it means that the user manually changes a setting and the process returns to ACT12.

Next, an operation example of an embodiment corresponding to FIG. 16 will be described.

The scanner 20 initializes the communication module 22 (ACT11). Next, the scanner 20 immediately verifies whether the LAN cable is connected (ACT12A).

When the LAN cable is connected (Yes in ACT12A), the server assistance processing is performed (ACT13). Conversely, when the LAN cable is not connected (No in ACT12A), the abnormality monitoring function is turned off (ACT15A) and standalone client processing is performed (ACT15B). In this operation, when the LAN cable is not connected, the abnormality monitoring function 23 is simply turned off. Therefore, the abnormality monitoring function detect any 23 does not abnormality and the standalone client processing can be performed without problem.

After the server assistance process is performed, it is next determined whether the abnormality monitoring function 23 detects an abnormality in the communication path (ACT14). If the abnormality monitoring function 23 detect an abnormality in the communication path (Yes in ACT14), the process ends. If the abnormality monitoring function 23 does not detect an abnormality in the communication path (No in ACT14), the process proceeds to ACT16.

When the standalone client processing is performed, the process continues (ACT16) and then ultimately returns to ACT12, and the process is repeated.

### Operations of Scanner and Image Recognition Apparatus

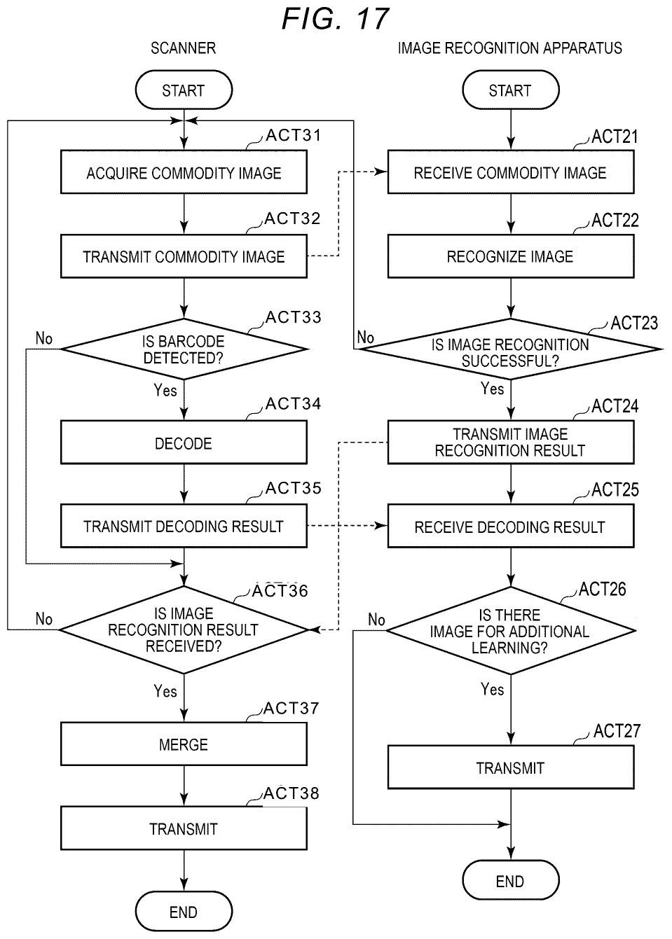

Next, operations of the scanner 20 and the image recognition apparatus 30 for specifying a commodity code of a commodity depicted in a commodity image that is a captured with the scanner 20 during commodity registration process will be described with reference to FIG. 17. FIG. 17 is a flowchart of operations of the scanner 20 and the image recognition apparatus 30 according to an embodiment. In FIG. 17, operations of the scanner 20 are illustrated on the left and operations of the image recognition apparatus 30 are illustrated on the right. The operations of the scanner 20 are performed by the scanner 20 executing the control program 211 or the like. The operations of the image recognition apparatus 30 are performed the image recognition apparatus 30 executing the control program 311.

In ACT31, the scanner 20 acquires the commodity image which may be one captured image from a video (video stream) captured by the imaging unit 220. For example, the scanner 20 first stores all or some of a plurality of frame images sequentially captured by the imaging unit 220 as candidates for the commodity image in the RAM 203. Subsequently, the scanner 20 selects one frame image among the plurality of frame images stored in the RAM 203. Typically, the scanner 20 assigns an identification code to the commodity image, however, for convenience, in this explanation, it can be assumed that the commodity image includes the identification code as part thereof.

In ACT32, the scanner 20 transmits the commodity image to the image recognition apparatus 30 via the LAN, for example, through TCP communication.

In ACT21, the image recognition apparatus 30 receives the commodity image (and its identification code) from the scanner 20 via the LAN. The image recognition apparatus 30 stores the received commodity image in the RAM 303.

In ACT22, the image recognition apparatus 30 performs the image recognition on the commodity image. For example, the image recognition apparatus 30 performs the image recognition based on feature data such as contours, colors, or the like in the commodity image. Here, the image recognition apparatus 30 first acquires the feature data included in the commodity image by image analysis or the like. Subsequently, the image recognition apparatus 30 searches for the feature data of an entry closest to the acquired feature data by comparing the acquired feature data with the comparison dictionary 313. Subsequently, the image recognition apparatus 30 acquires the commodity code associated with feature data closest to the acquired feature data (a search result).

In ACT23, the image recognition apparatus 30 determines whether the image recognition was successful. For example, the image recognition apparatus 30 calculates a difference (a difference value) between the acquired feature data and the feature data closest to the acquired feature data. Subsequently, the image recognition apparatus 30 compares the difference (difference value) to some predetermined amount (threshold level).

When the difference is less than the predetermined amount, the image recognition apparatus 30 determines that the image recognition is successful. Here, the image recognition apparatus 30 stores the commodity code acquired in ACT22 as an image recognition result in the RAM 303. Thereafter, the operation proceeds to an operation of ACT24.

Conversely, when the difference is greater than or equal to the predetermined amount, the image recognition apparatus 30 determines that the image recognition failed. Here, the image recognition apparatus 30 requests the scanner 20 to acquire and transmit another commodity image and then performs operations of ACT21 to ACT23 again. The image recognition apparatus 30 also determines that the commodity image subjected to the image recognition that can be a commodity image to be used for additional learning.

In ACT24, the image recognition apparatus 30 transmits an image recognition result stored in the RAM 303 to the scanner 20 via the LAN. The image recognition apparatus 30 transmits the identification code to the scanner 20.

In ACT33, the scanner 20 attempts to detect the commodity barcode in the commodity image. In other words, the scanner 20 checks whether the commodity barcode is visible in the commodity image.

When the commodity barcode is detected in ACT33 (Yes in ACT33), the scanner 20 extracts and then decodes, in ACT34, the detected commodity barcode and acquires the commodity code stored in the commodity barcode as a decoding result. The scanner 20 stores the acquired commodity code in the RAM 203.

Subsequently, in ACT35, the scanner 20 transmits the commodity code (barcode decoding result) to the image recognition apparatus 30. The operations of ACT34 and ACT35 are operations that occur only if the commodity barcode is detected in ACT33. In some cases, the scanner 20 does not transmit a commodity code from the barcode decoding such as when no barcode is present on the commodity or otherwise.

In ACT36, the scanner 20 verifies whether the image recognition result for the commodity image (the commodity code of the commodity in the commodity image) was received from the image recognition apparatus 30. When an image recognition result is received (Yes in ACT36), the scanner 20 stores the received image recognition result in the RAM 203. The scanner 20 may specify the commodity image corresponding to the image recognition result based on an identification code received along with the image recognition result. Thereafter, the operation proceeds to a merging operation of ACT37.

When the commodity barcode cannot be detected in ACT33 (No in ACT13), the operations of ACT34 and ACT35 are skipped and the operation proceeds to verifying reception of the image recognition result in ACT36.

When the image recognition result is not received in ACT36 (No in ACT36), the scanner 20 repeatedly performs (attempts) the operations of ACT31 and ACT33 to ACT35. Here, the image recognition apparatus 30 may omit the transmission of the commodity image in ACT32 since a new commodity image might not be necessary. That is, until an image recognition result is received from the image recognition apparatus 30, the scanner 20 continues a series of regular operations for the acquisition of the commodity image in ACT31, the detection of the commodity barcode in ACT33, the decoding in ACT34, and the transmission of the commodity code (decoding result) in ACT35.

In ACT37, the scanner 20 merges the decoding result (the commodity code from the commodity barcode) and the image recognition result (the commodity code of the commodity recognized in the commodity image). In this merging process, the scanner 20 acquires (selects) the one commodity code considered to be most correct between the decoding result and the image recognition result.

When a decoding result is not obtained, the commodity code from the image recognition is the merged result. The decoding result might not be obtained in various situations, such as, there are cases where the customer does not correctly hold the commodity barcode towards the imaging unit 220 of the scanner 20, or the commodity barcode is unnaturally bent, folded, defaced, or the like.

When both a decoding result and an image recognition result are obtained, the scanner 20 compares the decoding result to the image recognition result. When the decoding result matches the image recognition result, the scanner 20 supplies the matched commodity code as the merged result. Conversely, when the decoding result dees not match the image recognition result, the scanner 20 generally uses the commodity code from the more reliable decoding process as the merged result.

In ACT38, the scanner 20 transmits the merged result (the one commodity code considered to be most correct) to the POS terminal 10.

If the scanner 20 transmits a commodity code decoded from the commodity barcode in ACT35, the image recognition apparatus 30 receives the commodity code in ACT25. The image recognition apparatus 30 stores the received commodity code that is the decoding result in the RAM 303.

In ACT26, the image recognition apparatus 30 determines whether there is a commodity image to be used for additional learning. For example, when there is a commodity image for which the image recognition failed in ACT23 but the commodity code (barcode decoding result) is received from the scanner 20 in ACT25, the image recognition apparatus 30 determines that there is a commodity image to be used for additional learning.

When, in ACT26, there is a commodity image to be used for additional learning, the image recognition apparatus 30 transmits the commodity image and the corresponding commodity code that was stored in the RAM 303 to the server 40 in ACT27.

When it is determined in ACT26 that there is no commodity image to be used for additional learning, the operation of ACT27 is skipped and the operation ends.

### Summary of Embodiment

According to an embodiment, the control unit 2006 disables the abnormality monitoring function 23 so that the standalone client operating mode will not be hindered when the LAN cable is not connected to the LAN interface 222, but enables the abnormality monitoring function 23 so that communication with the server can be monitored by the abnormality monitoring function 23 in the client operating mode when the LAN cable is connected to the LAN interface 222. Accordingly, an operator does not need to manually turn off (switch or change a setting related to) the abnormality monitoring function 23 when switching operating modes between client operating mode and standalone operating mode. Whenever the LAN cable is connected to the LAN interface 222, abnormality monitoring function 23 operates normally (effectively). Therefore, if an abnormality occurs in a communication path, such an abnormality can be detected reliably.

According to an embodiment, the control unit 2006 disables the abnormality monitoring function 23 after the system is started and the LAN interface 222 is initialized if the LAN cable is not connected to the LAN interface 222. Accordingly, it is possible to avoid the abnormality monitoring function 23 from detecting a non-connection of the LAN cable as an abnormality right after the LAN interface 222 is initialized.

According to an embodiment, the control unit 2006 can change the abnormality monitoring function 23 from a disabled state to an enabled state when the LAN cable is connected to the LAN interface 222 after previously being disconnected. Accordingly, the standalone operating mode can smoothly transition to a client operating mode in which cooperation with an external server or the like can be utilized. In particular, the abnormality monitoring function 23 can be utilized effectively even when the LAN cable is connected to the LAN interface 222 after the non-connection.

According to an embodiment, the control unit 2006 can determine whether the LAN cable is connected to the LAN interface by verifying whether a link speed is set with respect to the LAN interface 222 by the LAN connection information 213. Accordingly, it is possible to easily verify whether the LAN cable is connected to the LAN interface even when a mechanical connection of the LAN cable is not otherwise easily verified.

### Others

In certain embodiments, the control programs executed by the POS terminal 10, the scanner 20, the image recognition apparatus 30, and the server 40 may be stored and provided on a computer-readable medium such as a CD-ROM. The control programs executed by the POS terminal 10, the scanner 20, the image recognition apparatus 30, and the server 40 may be stored on a computer connected to a network such as the Internet and may be provided by downloading via the network or may be otherwise provided via a network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a local area network (LAN) interface including an abnormality monitoring function for monitoring whether a communication path is abnormal; and
a control unit configured to:
disable the abnormality monitoring function of the LAN interface when it is determined a LAN cable is not connected to the LAN interface, and
enable the abnormality monitoring function when it is determined the LAN cable is connected to the LAN interface.

2. The information processing apparatus according to claim 1, wherein the control unit is further configured to:
initialize the LAN interface at startup, and
the control unit determines whether the LAN cable is connected to the LAN interface or not immediately after the startup.

3. The information processing apparatus according to claim 2, wherein the control unit is further configured to:
periodically determine whether the LAN cable is connected to the LAN interface or not after startup.

4. The information processing apparatus according claim 3, wherein the control unit enables the abnormality monitoring function after previously disabling the abnormality function when the LAN cable is connected to the LAN interface after previously being disconnected.

5. The information processing apparatus according to claim 1, wherein the control unit determines whether the LAN cable is connected to the LAN interface by checking whether a link speed parameter for the LAN interface has been set.

6. A product scanner for commodity registration systems, the product scanner comprising:
an imaging unit for capturing images of items being purchased in a sales transaction at a point-of-sale terminal;
a local area network (LAN) interface including an abnormality monitoring function for monitoring whether a communication path to an image recognition apparatus is abnormal; and
a control unit configured to:
disable the abnormality monitoring function of the LAN interface when it is determined a LAN cable is not connected to the LAN interface, and
enable the abnormality monitoring function when it is determined the LAN cable is connected to the LAN interface.

7. The product scanner according to claim 6, wherein the control unit is further configured to:
initialize the LAN interface at startup, and
the control unit determines whether the LAN cable is connected to the LAN interface or not immediately after the startup.

8. The product scanner according to claim 7, wherein the control unit is further configured to:
periodically determine whether the LAN cable is connected to the LAN interface or not after startup.

9. The product scanner according to claim 8, wherein the control unit enables the abnormality monitoring function after previously disabling the abnormality function when the LAN cable is connected to the LAN interface after previously being disconnected.

10. The product scanner according to claim 6, wherein the control unit determines whether the LAN cable is connected to the LAN interface by checking whether a link speed parameter for the LAN interface has been set.

11. The product scanner according to claim 6, wherein the control unit is further configured to:
detect an encoded product code in a captured image from the imaging unit.

12. The product scanner according to claim 11, wherein the control unit is further configured to:
decode the encoded product code and send a decoded product code to the point-of-sale terminal.

13. The product scanner according to claim 11, wherein the control unit is further configured to send the captured image to the image recognition apparatus via the LAN cable if the LAN cable is determined to be connected to the LAN interface.

14. An information processing method for a product scanner, the method comprising:
disabling an abnormality monitoring function of a LAN interface when it is determined a LAN cable is not connected to the LAN interface; and
enabling the abnormality monitoring function when it is determined the LAN cable is connected to the LAN interface.

15. The information processing method according to claim 14, the method further comprising:
initializing the LAN interface at a startup; and
determining whether the LAN cable is connected to the LAN interface or not immediately after the startup.

16. The information processing method according to claim 15, the method further comprising:
periodically determining whether the LAN cable is connected to the LAN interface or not after startup.

17. The information processing method according claim 16, wherein the abnormality monitoring function is enabled after a previous disabling of the abnormality function when the LAN cable is connected to the LAN interface after previously being disconnected.

18. The information processing method according to claim 14, further comprising:
determining whether the LAN cable is connected to the LAN interface by checking whether a link speed parameter for the LAN interface has been set.
